(19) United States
(12) Patent Application Publication
(10) Pub. No.: US 2024/0014413 A1
(43) Pub. Date: Jan. 11, 2024

(54) BIPOLAR PLATE FOR AN ELECTROCHEMICAL CELL, ARRANGEMENT OF ELECTROCHEMICAL CELLS, AND METHOD FOR OPERATING SAID ARRANGEMENT OF ELECTROCHEMICAL CELLS

(71) Applicant: Robert Bosch GmbH, Stuttgart (DE)

(72) Inventors: Christian Diessner, Muehlacker-Muehlhausen (DE); Harald Schmeisser, Stuttgart (DE); Jochen Wessner, Esslingen (DE); Stefan Schoenbauer, Ditzingen (DE); Ulrich Berner, Stuttgart (DE)

(21) Appl. No.: 18/254,005

(22) PCT Filed: Oct. 25, 2021
(86) PCT No.: PCT/EP2021/079472

§ 371 Date: May 23, 2023

(30) Foreign Application Priority Data
Nov. 30, 2020 (DE) 10 2020 215 011.7

(51) Int. Cl. H01M 8/0297; H01M 8/0271; H01M 8/0254

(52) U.S. Cl. CPC H01M 8/0297; H01M 8/0271; H01M 8/0254

(57) ABSTRACT

The invention relates to a bipolar plate (7) for an electrochemical cell (1), said bipolar plate comprising a first monopolar plate (13) and a second monopolar plate (17), at least one port (55), a seal (47), and an active surface (53), wherein the first monopolar plate (13) and/or the second monopolar plate (17) have at least one opening element (111) for the passage of at least one medium (29), the at least one opening element (111) is located between the at least one port (55) and the active surface (53) and has a first opening surface (113) and a second opening surface (115), wherein the first opening surface (113) and the second opening surface (115) have a common lateral line (117), and the first opening surface (113) and the second opening surface (115) are arranged at a deflection angle (119) to one another in a range of 30° to 120°. The invention also relates to an arrangement (69) of electrochemical cells (1) and to a method for operating the arrangement (69) of electrochemical cells (1).

### BACKGROUND

The invention relates to a bipolar plate for an electrochemical cell comprising a first monopolar plate and a second monopolar plate, at least one port, a seal, and an active surface. Furthermore, the invention relates to an arrangement of electrochemical cells comprising at least the bipolar plate and at least one membrane-electrode arrangement, as well as a method for operating the arrangement of electrochemical cells.

Electrochemical cells are electrochemical energy converters and are known in the form of fuel cells or electrolyzers.

A fuel cell converts chemical reaction energy into electrical energy. In known fuel cells, hydrogen (H₂) and oxygen (O₂) are in particular converted to water (H₂O), electrical energy, and heat.

Among others, proton-exchange membrane (PEM) fuel cells are known. Proton-exchange membrane fuel cells comprise a centrally arranged membrane that is permeable to protons, i.e. hydrogen ions. The oxidizing agent, in particular atmospheric oxygen, is thereby spatially separated from the fuel, in particular hydrogen.

Fuel cells comprise an anode and a cathode. The fuel is continuously supplied to the fuel cell at the anode and catalytically oxidized with loss of electrons to form protons that reach the cathode. The lost electrons are discharged from the fuel cell and flow via an external circuit to the cathode. The oxidizing agent is supplied to the fuel cell at the cathode and reacts to form water by receiving the electrons from the external circuit and protons. The resulting water is drained from the fuel cell. The gross reaction is:

O₂+4H⁺+4e⁻→2H₂O

A voltage is applied between the anode and the cathode of the fuel cell. In order to increase the voltage, multiple fuel cells can be mechanically arranged one behind the other to form a fuel cell stack, which can also be referred to as a fuel cell setup, and can be electrically connected in series.

A stack of electrochemical cells, which can be referred to as an arrangement of electrochemical cells, typically has end plates that press the individual cells together and impart stability to the stack.

The electrodes, i.e. the anode and the cathode, and the membrane can be structurally assembled to form a membrane-electrode assembly (MEA).

Stacks of electrochemical cells further have bipolar plates, also referred to as gas distributor plates or distributor plates. Bipolar plates serve to distribute the fuel evenly to the anode and to distribute the oxidizing agent evenly to the cathode. In addition to the media guidance with respect to oxygen, hydrogen, water, and if applicable a coolant, the bipolar plates ensure a planar electrical contact to the membrane.

A fuel cell stack typically comprises up to a few hundred individual fuel cells stacked one on top of the other in layers. The individual fuel cells comprise one MEA as well as in each case one bipolar plate half on the anode side and on the cathode side. In particular, a fuel cell comprises an anode monopolar plate and a cathode monopolar plate, typically in each case in the form of embossed sheets, which together form the bipolar plate and thus form channels for guiding gas and liquids, between which the cooling medium can flow.

Furthermore, electrochemical cells typically comprise gas diffusion layers arranged between a bipolar plate and a MEA.

By contrast to a fuel cell, an electrolyzer is an energy converter, which, while applying electrical voltage, preferably splits water into hydrogen and oxygen. Electrolyzers also have MEAs, bipolar plates, and gas diffusion layers, among other things.

Electrochemical cells in a stack are often supplied with the media, in particular hydrogen and oxygen, or these media are discharged via media channels arranged perpendicular to the membrane of the electrochemical cell. The media channels are fluidly connected to the electrochemical cells, in particular to the bipolar plates, by ports that can also be referred to as fluid terminals. The media channels are typically located on the edge of the stack and are often generated by congruently overlapping recesses forming the ports. From the ports, the media are fed through port grommets into the so-called flow-field, the active surface of the bipolar plate and the membrane, respectively.

In particular, the port grommets for air or hydrogen facing the MEA are to be designed so that the port grommets provide as large an opening as possible for the inflowing and outflowing media and on the other hand provide as good a mechanical support effect for seals arranged on the opposite side of the MEA.

The active surface as well as the ports of the bipolar plates must be sealed and at the same time must ensure that the media can be guided securely into the associated channels when the sealing is present so that an even reaction and generation of electrical energy is possible. This must also to be ensured when high tensioning forces are present in an arrangement of electrochemical cells, wherein the grommets may not be crushed, occluded, or blocked.

DE 10158772 C1 and DE 10248531 B4 relate to fuel cell stacks with a layering of multiple fuel cells, wherein media are fed or discharged by bipolar plates and bead arrangements are provided for the sealing.

### SUMMARY

A bipolar plate for an electrochemical cell is proposed, said bipolar plate comprising a first monopolar plate and a second monopolar plate, at least one port, a seal, and an active surface, wherein the first monopolar plate and/or the second monopolar plate have at least one opening element for the passage of at least one medium, the at least one opening element is located between the at least one port and the active surface and has a first opening surface and a second opening surface, wherein the first opening surface and the second opening surface have a common lateral line, and the first opening surface and the second opening surface are arranged at a deflection angle to one another in a range of 30° to 120°, preferably 30° to 90°, further preferably 60° to 90°.

Furthermore, an arrangement of electrochemical cells is proposed, comprising at least one bipolar plate according to the invention and at least one membrane electrode arrangement, wherein the at least one opening element is arranged on the at least one bipolar plate such that a lateral surface of the at least one opening element abuts the at least one membrane electrode arrangement or the respective other monopolar plate.

In addition, a method for operating the arrangement of electrochemical cells is proposed, wherein the at least one medium is passed from the at least one port through the at least one opening element to the active surface, and a direction of flow of the at least one medium is deflected about the deflection angle as it passes through the first monopolar plate or through the second monopolar plate.

Preferably, the electrochemical cell, which is preferably a fuel cell or an electrolyzer, preferably comprises at least one bipolar plate according to the invention, at least one gas diffusion layer, and at least one membrane or membrane-electrode arrangement. In particular, a membrane-electrode arrangement is respectively arranged between two bipolar plates. Preferably, the arrangement of electrochemical cells, which is preferably a fuel cell stack, comprises at least one membrane-electrode arrangement, at least one bipolar plate according to the present invention, further preferably at least two bipolar plates according to the present invention, and at least one port. The at least one port can be an inlet or an outlet.

The bipolar plate preferably has carbon such as graphite, a metal such as stainless steel or titanium, and/or an alloy containing the metal. Further preferably, the bipolar plate is constructed of carbon, metal, and/or alloy.

Preferably, the at least one medium comprises hydrogen, air or oxygen, water, and/or a cooling medium, and further preferably the at least one medium comprises the cooling medium, hydrogen, or a mixture containing oxygen and/or water.

The at least one opening element can also be referred to as a passage element, breakthrough element, or interruption element of the first monopolar plate or of the second monopolar plate. Preferably, the first monopolar plate and/or the second monopolar plate comprise a plurality of opening elements.

Furthermore, the opening element can be referred to as a shaft. The opening element preferably has a lateral surface extending from the first opening surface to the second opening surface. In particular, the at least one opening element consists of the first opening surface, the second opening surface, and the lateral surface. The lateral surface is further preferably straight, bent, and/or kinked. In the case of a kinked lateral surface, in particular a sub-surface of the lateral surface is arranged parallel to a base plate of the first monopolar plate or the second monopolar plate. In particular, the lateral surface connects the first opening surface to the second opening surface. Preferably, the first opening surface and/or the second opening surface have a substantially rectangular shape, wherein rounded corners can be present.

The opening element is preferably produced by means of cutting and reshaping from the first monopolar plate or the second monopolar plate, wherein in particular the first opening surface, the second opening surface, and the lateral surface are formed. By forming the lateral surface, the at least one medium can flow through the first opening surface.

Preferably, the first opening surface lies in a base plate, also referred to as a base surface or floor surface, of the first monopolar plate or the second monopolar plate, wherein in particular in the production of the opening element, the lateral surface has been removed from the base plate.

Preferably, the first opening surface is larger than the second opening surface. Furthermore, the second opening surface is preferably formed by an in particular fully open side of the at least one opening element.

Preferably, the seal surrounds the at least one port. The seal can exclusively surround the at least one port, preferably exclusively precisely one port. Furthermore, the seal can surround the active surface. The at least one opening element is preferably arranged on the seal so that the at least one medium can overcome the seal through the opening element.

Preferably, the seal is a seal bead, further preferably a metallic seal bead. More preferably, the at least one opening element is arranged in the sealing bead so that the at least one medium can overcome the sealing bead through the opening element.

Alternatively, the bipolar plate can include a seal, comprising an in particular elastic sealing material such as a polymer, wherein the at least one opening element is preferably arranged in the base plate of the first monopolar plate and the second monopolar plate on the seal, such that the seal can be overcome by means of the at least one opening element for carrying out the at least one medium from the at least one port to the active surface of the bipolar plate.

Preferably, the bipolar plate comprises at least two opening elements. The at least two opening elements are further preferably arranged in at least one row or offset from one another. The at least two opening elements can be arranged at a substantially equal distance to one another and/or can have a substantially equal width. Alternatively, the at least two opening elements can be arranged at different distances from one another and/or can have a respective different width. Furthermore, the at least two opening elements can be arranged with alternatingly different widths.

The distance is understood in particular to mean the shortest connection between two adjacent opening elements. A substantially equal distance and a substantially equal width is understood in particular to mean that a distance or a width has not more than 30%, in particular not more than 10%, of a mean distance or a mean width of all opening elements present on the bipolar plate.

With the at least one opening element, it is ensured that the at least one medium is passed through a sealing element even at high tensioning forces in an arrangement of electrochemical cells. Media can be conducted from the at least one port into the associated channel structure of the active surface and, at the same time, the at least one opening element serves to support the individual components of the arrangement of electrochemical cells, in particular through its lateral surface, in particular the bipolar plates or the monopolar plates and/or the membrane-electrode arrangement with respect to one another, in order to prevent unwanted compression and thus a partial blockage of the media supply. Accordingly, the at least one opening element also serves as a spacer between adjacent components of the arrangement of electrochemical cells. In particular, when the lateral surface has a kinked or angular shape, a laminar support is ensured by the at least one opening element.

### BRIEF DESCRIPTION OF THE DRAWINGS

Embodiments of the invention are explained in more detail with reference to the drawings and the following description.

The drawings show:

FIG. 1 a schematic illustration of an electrochemical cell,

FIG. 2 a plan view of a section of a bipolar plate,

FIG. 3 a cross-sectional view of a section of an arrangement of electrochemical cells,

FIG. 4 an opening element according to the invention on a bipolar plate,

FIG. 5 a cross-sectional view of a section of a bipolar plate with a sealing bead,

FIG. 6 a cross-sectional view of a section of a bipolar plate with a sealing bead and an opening element according to the invention,

FIG. 7 a cross-sectional view of a section of a bipolar plate with a seal and an opening element according to the invention,

FIG. 8 a first embodiment of an opening element,

FIG. 9 a second embodiment of an opening element, and

FIG. 10 a third embodiment of an opening element.

### DETAILED DESCRIPTION

In the following description of the embodiments of the invention, identical or similar elements are denoted by identical reference numbers, wherein a repeated description of these elements is omitted in individual cases. The figures show the subject-matter of the invention only schematically.

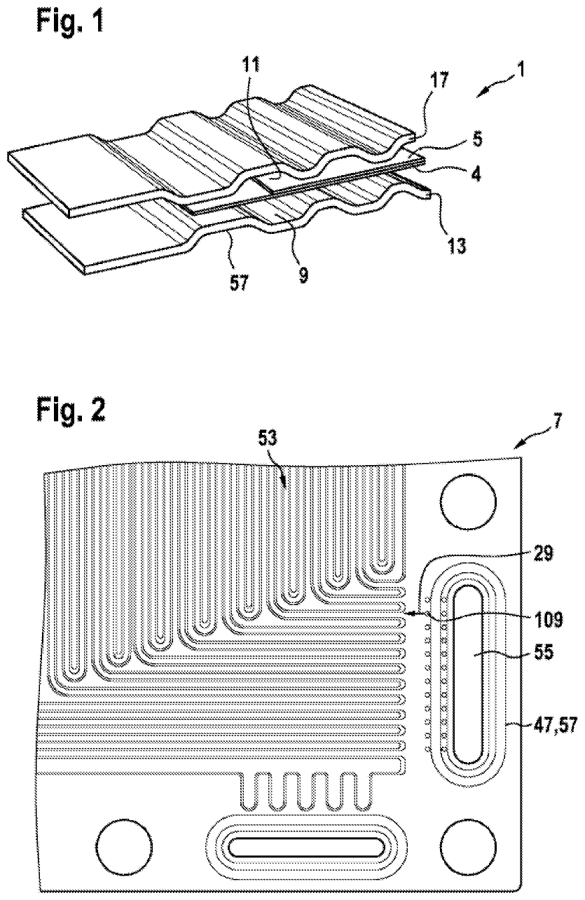

FIG. 1 schematically shows an electrochemical cell 1 in the form of a fuel cell. The electrochemical cell 1 comprises a membrane-electrode arrangement 4, gas diffusion layers 5, as well as a first monopolar plate 13 and a second monopolar plate 17. Oxygen 9 passes between the first monopolar plate 13 and the membrane electrode arrangement 4, and hydrogen 11 passes between the second monopolar plate 17 and the membrane electrode arrangement 4. The hydrogen 11 and oxygen 9 are sealed against one another in the membrane-electrode arrangement 4 by a sealing bead 57.

FIG. 2 shows a top plan view of a section of a bipolar plate 7 comprising a port 55 and an active surface 53 as well as a seal 47 in the form of a sealing bead 57. A medium 29, which can comprise hydrogen 11 or oxygen 9, is fed from the port 55 through breakthroughs 109 according to the prior art through the seal 47 to the active surface 53.

FIG. 2 shows a cross-sectional view of a section of a bipolar plate 7 with a sealing bead 57 comprising a breakthrough 109 according to the prior art.

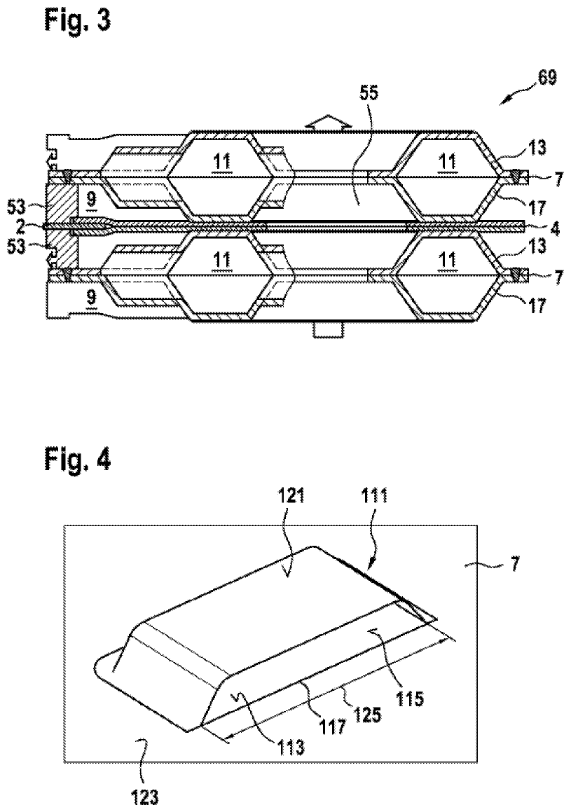

FIG. 3 shows a cross-sectional view of a section of an arrangement 69 of electrochemical cells 1. A membrane-electrode arrangement 4 is arranged between two bipolar plates 7. In particular, the section shows a port 55 from which hydrogen 11 is conducted towards the active surface 53 of the bipolar plates 7 and the membrane 2, respectively. The bipolar plates 7 have a respective first monopolar plate 13 and a second monopolar plate 17.

FIG. 4 shows an opening element 111 according to the invention, which can also be referred to as a shaft. The opening element 111 having a width 125 has a lateral surface 121 extending from a first opening surface 113 to a second opening surface 115. The first opening surface 113 and the second opening surface 115 have a common lateral line 117. Furthermore, the first opening surface 113 lies in a base plate 123 of the bipolar plate 7.

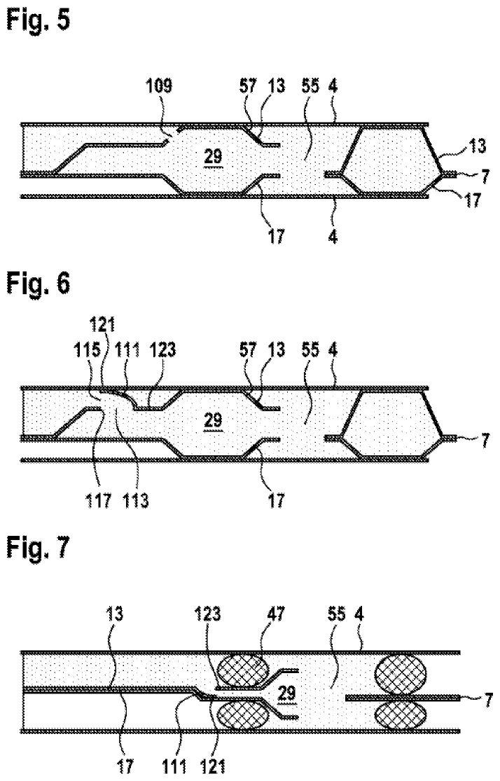

FIG. 5 shows a cross-sectional view of a section of a bipolar plate 7 with a sealing bead 57. A first monopolar plate 13 has a breakthrough 109 for passing a medium 29 from a port 55.

FIG. 6 shows a cross-sectional view of a section of a bipolar plate 7, which substantially corresponds to the bipolar plate 7 according to FIG. 5, with the difference that instead of the breakthrough 109, the medium 29 is guided through the opening element 111 according to the invention according to the prior art. The lateral surface 121 of the opening element 111 abuts and supports a membrane-electrode arrangement 4 that is arranged adjacent to the first monopolar plate 13 on which the opening element 111 is arranged and support it, so that the second opening surface 115 of the opening element 111 in particular is kept open in order for the medium 29 to flow through.

FIG. 7 shows a cross-sectional view of a section of a bipolar plate 7, which has an alternative embodiment of the seal 47 compared to FIGS. 5 and 6. The medium 29 overcomes the seal 47 via the opening element 111, which is arranged such that the lateral surface 121 of the opening element 111 located on the first monopolar plate 13 abuts and supports the second monopolar plate 17.

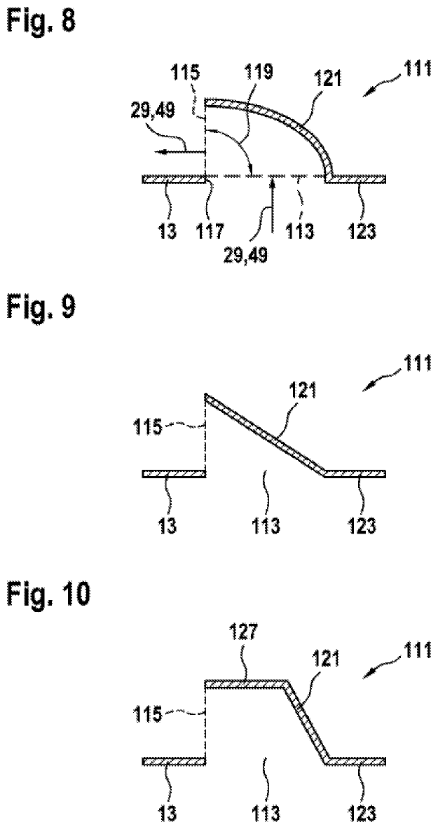

FIG. 8 shows a first embodiment of an opening element 111, wherein a curved lateral surface 121 is present. Furthermore, a deflection angle 119 as well as a direction of flow 49 of the medium 29 are marked. The first opening surface 113, which lies in a base plate 123 of the bipolar plate 7, is arranged at the deflection angle 119 to the second opening surface 115, which the medium 29 respectively flows through.

FIG. 9 shows a second embodiment of the opening element 111, wherein a straight lateral surface 121 is present.

FIG. 10 shows a third embodiment of the opening element 111, wherein a kinked lateral surface 121 is present. In the case of a kinked lateral surface 121, in particular, a sub-surface 127 of the lateral surface 121 is arranged parallel to the base plate 123.

The invention is not limited to the embodiment examples described here and the aspects highlighted therein. Rather, a variety of modifications, which are within the scope of activities of the person skilled in the art, is possible within the range specified by the claims.

1. A bipolar plate (7) for an electrochemical cell (1), said bipolar plate comprising a first monopolar plate (13) and a second monopolar plate (17), at least one port (55), a seal (47), and an active surface (53), wherein the first monopolar plate (13) and/or the second monopolar plate (17) have at least one opening element (111) for the passage of at least one medium (29), the at least one opening element (111) is located between the at least one port (55) and the active surface (53) and has a first opening surface (113) and a second opening surface (115), wherein the first opening surface (113) and the second opening surface (115) have a common lateral line (117), and the first opening surface (113) and the second opening surface (115) are arranged at a deflection angle (119) to one another in a range of 30° to 120°.

2. The bipolar plate (7) according to claim 1, wherein the opening element (111) has a lateral surface (121) extending from the first opening surface (113) to the second opening surface (115), and the lateral surface (121) is straight, bent, and/or kinked.

3. The bipolar plate (7) according to claim 1, wherein the first opening surface (113) lies in a base plate (123) of the first monopolar plate (13) or the second monopolar plate (17).

4. The bipolar plate (7) according to claim 1, wherein the first opening surface (113) is larger than the second opening surface (115).

5. The bipolar plate (7) according to claim 1, wherein the seal (47) is a sealing bead (57) and the at least one opening element (111) is arranged on the sealing bead (57).

6. The bipolar plate (7) according to claim 1, wherein the bipolar plate (7) comprises at least two opening elements (111).

7. The bipolar plate (7) according to claim 6, wherein the at least two opening elements (111) are arranged at a substantially equal distance to one another and/or have a substantially equal width (125).

8. The bipolar plate (7) according to claim 1, wherein the second opening surface (115) is formed by an open side of the at least one opening element (111).

9. An arrangement (69) of electrochemical cells (1) comprising at least one bipolar plate (7) according to claim 1 and at least one membrane electrode arrangement (4), wherein the at least one opening element (111) is arranged on the at least one bipolar plate (7) such that a lateral surface (121) of the at least one opening element (111) abuts the at least one membrane electrode arrangement (4) or the respective other monopolar plate (13, 17).

10. A method for operating an arrangement (69) of electrochemical cells (1) according to claim 9, wherein the at least one medium (29) is passed from the at least one port (55) through the at least one opening element (111) to the active surface (53), and a direction of flow (49) of the at least one medium (29) is deflected about the deflection angle (119) as it passes through the first monopolar plate (13) or through the second monopolar plate (17).

11. A bipolar plate (7) for an electrochemical cell (1), said bipolar plate comprising a first monopolar plate (13) and a second monopolar plate (17), at least one port (55), a seal (47), and an active surface (53), wherein the first monopolar plate (13) and the second monopolar plate (17) both have at least one opening element (111) for the passage of at least one medium (29), the at least one opening element (111) is located between the at least one port (55) and the active surface (53) and has a first opening surface (113) and a second opening surface (115), wherein the first opening surface (113) and the second opening surface (115) have a common lateral line (117), and the first opening surface (113) and the second opening surface (115) are arranged at a deflection angle (119) to one another in a range of 30° to 120°.

12. The bipolar plate (7) according to claim 1, wherein the opening element (111) has a lateral surface (121) extending from the first opening surface (113) to the second opening surface (115), and the lateral surface (121) is straight.

13. The bipolar plate (7) according to claim 1, wherein the opening element (111) has a lateral surface (121) extending from the first opening surface (113) to the second opening surface (115), and the lateral surface (121) is bent.

14. The bipolar plate (7) according to claim 1, wherein the opening element (111) has a lateral surface (121) extending from the first opening surface (113) to the second opening surface (115), and the lateral surface (121) is kinked.

15. The bipolar plate (7) according to claim 1, wherein the bipolar plate (7) comprises at least two opening elements (111) and the at least two opening elements (111) are arranged in at least one row or offset from one another.

16. The bipolar plate (7) according to claim 15, wherein the at least two opening elements (111) are arranged at a substantially equal distance to one another and have a substantially equal width (125).
